(19) United States
(12) Patent Application Publication
(10) Pub. No.: US 2004/0059613 A1
(43) Pub. Date: Mar. 25, 2004

(54) Online method and system for advising customers on service needs, facilitating the scheduling of vehicle service appointments, and checking vehicle service status

(75) Inventors: David John Ford, Canton, MI (US); John Garfield Graham, Plymouth, MI (US); Joseph Retzbach, Novi, MI (US); Kenneth James McCaffrey, Canton, MI (US); Nadine Ann Mooney, Livonia, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI

(21) Appl. No.: 10/064,962

(22) Filed: Sep. 4, 2002

(51) Int. Cl. G06F 17/60

(52) U.S. Cl. 705/8

(57) ABSTRACT

The present invention relates to an online method and system for advising customers on service needs, facilitating the scheduling of vehicle service appointments, and checking vehicle service status. A preferred method embodiment of the present invention includes receiving a service inquiry, receiving input information regarding the potential service of the vehicle, and transmitting the input information and an appointment request to a vehicle service provider to facilitate the scheduling of the vehicle service appointment. A preferred computer system of the present invention is configured to receive a service inquiry, receive input information regarding the potential service of the vehicle, and transmit the input information and an appointment request to a vehicle service provider to facilitate the scheduling of the vehicle service appointment.

### BACKGROUND OF INVENTION

1. Field of the Invention

This invention relates generally to an online method and system for advising customers on service needs, facilitating the scheduling of vehicle service appointments, and checking vehicle service status.

2. Background Art

Conventionally, scheduling a service appointment at an automobile dealership involves interacting with a dealership representative. A customer communicates his/her service request and availability to the dealership representative. Often, the customer communicates with the dealership representative via telephone calls, e-mail, or traditional mail.

The representative interprets the information provided by the customer and usually translates the information onto paper or enters the information into a dealer management system. Sometimes, the information is not translated or entered correctly, leading to errors in the scheduling of the service appointment or in the servicing of the customer's vehicle. As a result, the customer's confidence that their service needs will be accurately interpreted and processed in a timely manner at the dealership is relatively low.

In addition, the questions used by different representatives to identify symptoms of the vehicle problem vary greatly. Therefore, there is a lack of uniformity in the information obtained by the interaction between the customer and the representative. As a result, service needs are often improperly diagnosed, if diagnosed at all.

Moreover, conventional methods for scheduling service requests usually require that the service appointment request is made during regular operating hours of the dealership.

What is needed is an online interactive method and system for advising customers on service needs and facilitating the scheduling of service appointments which increases the uniformity of the scheduling process. In addition, an online interactive method and system is needed that allows customers to schedule appointments and advises customers of service needs beyond normal operating hours of the dealership. Moreover, an online interactive method and system is needed to allow customers to check vehicle service status.

### SUMMARY OF INVENTION

The present invention relates to an online method and system for advising customers on service needs, facilitating the scheduling of vehicle service appointment, and checking vehicle service status. One object of the present invention is to provide an online method and system for advising customers on service needs and facilitating the scheduling of service appointments which increases the uniformity of the scheduling process. Another object of the present invention is to provide an online interactive method and system that allows customers to schedule appointments and advises customers of service needs beyond normal operating hours.

A preferred method embodiment of the present invention includes receiving a service inquiry, receiving input information regarding the potential service of the vehicle, and transmitting the input information and an appointment request to a vehicle service provider to facilitate the scheduling of the vehicle service appointment. The service inquiry is selected from the group comprising: a service request, a scheduled maintenance request, a recall request, and a vehicle status request. If the service inquiry is a service request, the input information includes information defining vehicle symptoms pertinent to the service request. If the service inquiry is the scheduled maintenance request or the recall request, the input information includes a vehicle identification number or the vehicle make, vehicle model year, and vehicle model. The input information for the scheduled maintenance request or the recall request is used to determine whether service is advised for the vehicle. If the service inquiry is the vehicle status request, the input information includes an at least last name of a customer checking on the vehicle status wherein the input information is used to determine the vehicle status. It should be understood that scheduling of the vehicle service appointment is not facilitated if the service inquiry is the vehicle status request.

The preferred method embodiment of the present invention may additionally include receiving available appointment dates and arrival times from the vehicle service provider.

If the service inquiry is the vehicle maintenance request, the input information can be used to retrieve a vehicle maintenance schedule for the vehicle.

The preferred method embodiment of the present invention may include displaying the input information to the customer prior to transmitting the input information and the appointment request.

The preferred method embodiment of the present invention may include obtaining the vehicle symptoms by asking an at least two symptom probing questions.

A preferred system embodiment of the present invention includes a computer system for advising a customer on service needs, facilitating the scheduling of a vehicle service appointment, or checking vehicle service status. The preferred server system embodiment is configured to receive a service inquiry, receive input information regarding the potential service of the vehicle, and transmit the input information and an appointment request to a vehicle service provider to facilitate the scheduling of the vehicle service appointment. The service inquiry is selected from the group comprising: a service request, a scheduled maintenance request, a recall request, and a vehicle status request. If the service inquiry is a service request, the input information includes information defining vehicle symptoms pertinent to the service request. If the service inquiry is the scheduled maintenance request or the recall request, the input information includes a vehicle identification number or the vehicle make, vehicle model year and vehicle model. The input information for the scheduled maintenance request or the recall request is used to determine whether service is advised for the vehicle. If the service inquiry is the vehicle status request, the input information includes an at least last name of a customer checking on the vehicle status wherein the input information is used to determine the vehicle status. It should be understood that scheduling of the vehicle service appointment is not facilitated if the service inquiry is the vehicle status request.

The preferred system embodiment may be additionally configured to send a request XML package containing a request for available appointment dates and arrival times to the vehicle service provider and to receive a response XML package containing available appointment dates and arrival times.

The preferred system embodiment may be additionally configured to send a request XML package containing the appointment date and arrival time for the vehicle service appointment to a dealer server or dealer middleware server and to receive a response XML confirming the appointment date and arrival time.

The above objects and other objects, features and advantages of the present invention are readily apparent from the following detailed description of the best mode for carrying out the invention when taken in connection with the accompanying drawings.

### BRIEF DESCRIPTION OF DRAWINGS

FIG. 1 is a logical schematic diagram illustrating a preferred system for implementing the present invention;

FIG. 2 is a block flow diagram illustrating a preferred methodology for implementing the present invention;

FIG. 3 illustrates a preferred GUI for entering information regarding a vehicle service inquiry;

FIGS. 4a and 4b illustrate a preferred GUI for entering information pertinent to a vehicle maintenance request in accord with a preferred embodiment of the present invention;

FIGS. 5a and 5b illustrate a preferred GUI for displaying information pertinent to a vehicle maintenance request in accord with a preferred embodiment of the present invention;

FIGS. 6a and 6b illustrate a preferred GUI for entering owner and vehicle information in accord with a preferred embodiment of the present invention;

FIGS. 7a and 7b illustrate a preferred GUI for scheduling an appointment date and arrival time in accord with a preferred embodiment of the present invention;

FIG. 7c illustrates a preferred GUI for choosing a specific arrival time in accord with a preferred embodiment of the present invention;

FIGS. 8a and 8b illustrate a preferred GUI for displaying information relevant to the customer request(s) for the customer's review in accord with a preferred embodiment of the present invention;

FIGS. 9a and 9b illustrate a preferred GUI for displaying confirmed information regarding the appointment date and arrival time, the service request(s) and the vehicle in accord with a preferred embodiment of the present invention;

FIGS. 10a and 10b illustrate a preferred GUI for entering information necessary to check the service status; and

FIGS. 11a and 11b illustrate a preferred GUI for displaying information regarding the service status.

### DETAILED DESCRIPTION

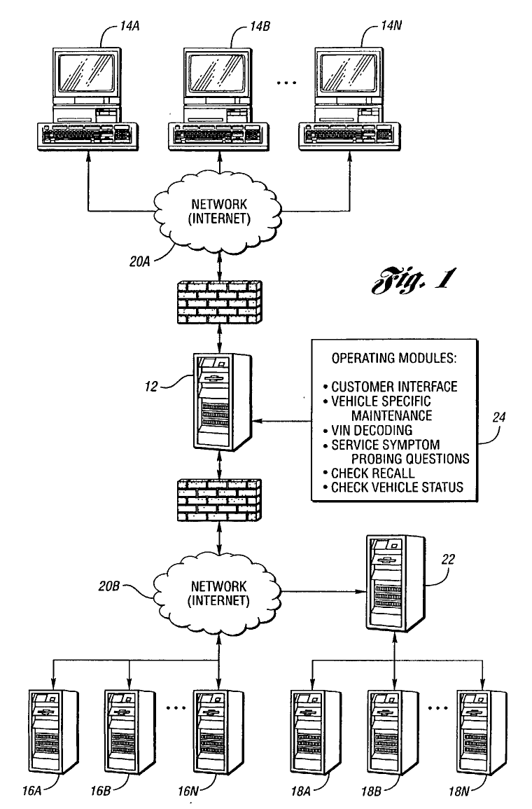

FIG. 1 is preferred logical schematic diagram implementing the present invention. FIG. 1 illustrates an at least one server computer 12 operably serving a plurality of customer client computers 14A-14N, a plurality of dealer in-house computers 16A-N and dealer middleware server 22 via networks 20A and 20B, respectively. It should be understood that server computer 12 can also operably service vehicle service providers that are not dealers. For example, server 12 can be configured to operably service non-OEM service shop in-house computers.

In accord with a preferred embodiment of the present invention, customer client computers 14A-14N communicate with server computer 12 utilizing a TCP-IP communication via the Internet. In accord with a preferred embodiment, the Internet connection can be a dealer website or other web application. Dealer in-house computers 16A-N preferably communicate with server computer 12 utilizing a TCP-IP communication protocol via the Internet, including XML protocol. Dealer in-house computers 18A-N preferably communicate with dealer middleware server 22 utilizing a TCP-IP communication protocol via the Internet, including XML protocol.

Server computer 12 is configured to operably execute operating modules 24, including the customer interface module, the vehicle specific maintenance module, the VIN decoding module, the check recall module, the check vehicle status module, and the service symptom probing question module.

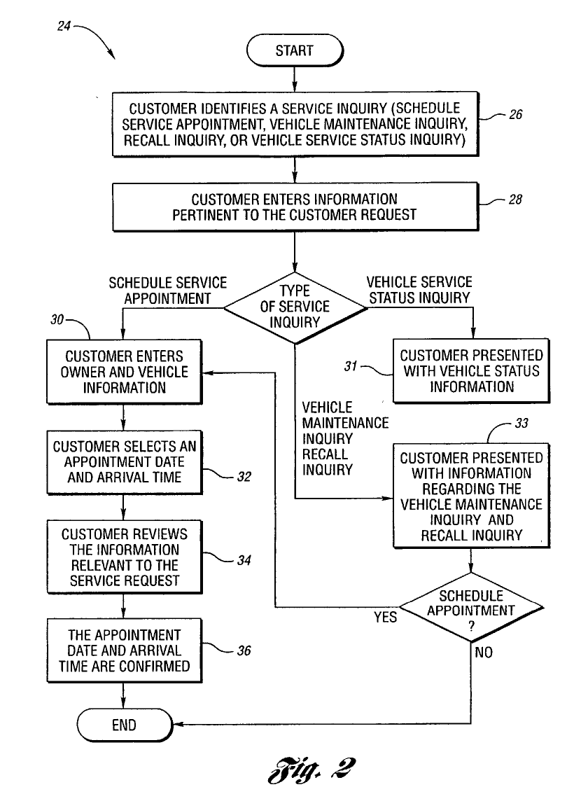

FIG. 2 is a block flow diagram illustrating a preferred methodology 24 for implementing the present invention. As represented in block 26, a customer identifies a service inquiry, which can be a schedule service appointment request, a vehicle maintenance inquiry, a recall inquiry, or a vehicle service status inquiry. Preferably, the customer identifies the service inquiry from a graphical user interface (GUI) hosted by server 12. The GUI, like other GUIs provided in accord with the present invention, may be developed and/or configured utilizing a plurality of client-server interface languages and applications including but not limited to hypertext markup language (HTML), Java Servlets and Java Script. Preferably, the GUI comprises a “Schedule Appointment” button, a “Vehicle Maintenance” button, a “Check Recalls” button, and a “Service Status” button. Additionally, the GUI preferably comprises instructional text, which aids the customer in making their selection.

As represented in block 28, the customer enters information pertinent to the service inquiry. Preferably, the customer can enter information pertinent to multiple service inquiries prior to scheduling a service appointment. For example, the customer can inquire about a vehicle maintenance schedule. After the customer interface module 24 displays the vehicle maintenance schedule, the customer can either decide to schedule a service appointment, identify another service inquiry, or exit the system. Under choice two, the customer can enter information pertinent to a schedule service appointment request. After entering the information pertinent to the two service inquiries, the customer can schedule a service appointment date and arrival time for regular maintenance and the service request, or enter information regarding yet another service inquiry.

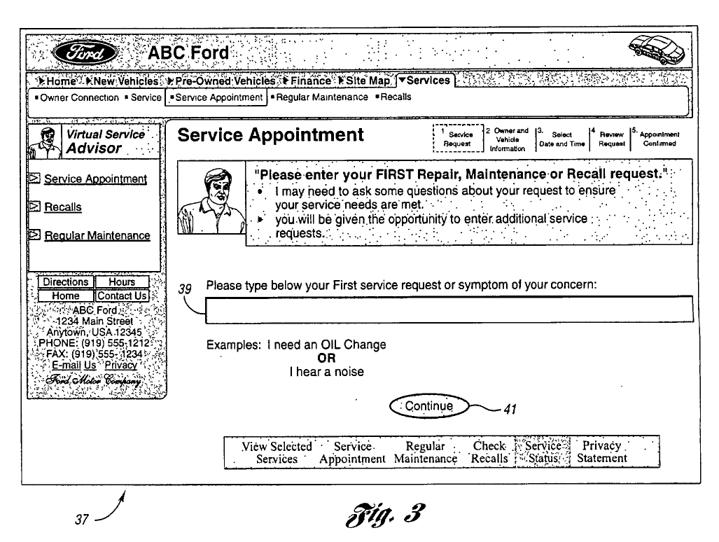

If the customer identifies the schedule service appointment request, an at least one GUI hosted by server 12 is preferably utilized for entering the information pertinent to the service appointment request. As depicted as FIG. 3, a first service request GUI 37 preferably contains a data input field 39 for entering a service request or a symptom relating to the customer's service request. For example, the customer can enter “I need an Oil Change” or “I hear a noise”. Preferably, once the customer completes entering the service request into data input field 39, the customer selects “Continue” button 41 that is contained on the first service request GUI.

Upon selecting the “Continue” button 41, the customer can be presented with an at least two symptom probing questions, depending on the information typed in data input field 39. The at least two symptom probing questions are selected by the service symptom probing question module 24 hosted by server 12. Preferably, the service symptom probing question module 24 searches the text entered into the data input field of the first service request GUI to identify the at least two symptom probing questions.

For example, if the customer enters any of the following in the data input field of the first service request GUI: “shift” sub-string, “upshift” sub-string, “downshift” sub-string, “engage” sub-string, “automatic transmission”, “trans”, “transaxle”, or “shift level”, the customer is presented with a series of symptom probing questions relating to an automatic transmission problem. It should be understood that sub-string refers to a series of characters that are contained within a word. For example, “upshift” is a sub-string of upshifting, upshifted, upshift, etc.

Preferably, a first symptom probing question relating to the automatic transmission concern is, “When do you notice your automatic transmission concern?” Through a GUI interface, the customer is preferably presented with a list of possible responses, which include, but are not limited to, the following: “At Gear Selection”, “After Gear Selection”, “Normal Acceleration”, “Heavy Acceleration”, “Steady Speed”, “Deceleration”, “Coasting Down”, “Braking”, “Reverse”, “Other”, “Not Sure”, etc. If the customer chooses “Other”, the customer is prompted with a first symptom probing sub-question: “Please indicate specifically when the shifting concern is experienced.” Preferably, the customer indicates a response in a GUI data input field. Preferably, a second symptom probing question is, “At what speed range does the transmission concern happen?” Through a GUI interface, the customer is preferably presented with a list of speed ranges to respond to the second symptom probing question. Preferably, a third symptom probing question is, “Describe how the transmission concern feels.” Possible responses preferably include, “Slips on Light Acceleration”, “Hard Upshift”, “Mushy Downshift”, “Other”, “Not Sure”, etc. If the customer chooses “Other”, the customer is prompted, preferable in a GUI data input field, to indicate specifically how the transmission concern feels.

The responses to the symptom probing questions at least temporarily reside on server 12. The responses, as well as other information, comprise a request XML package that is sent to a dealer in-house computer.

According to the present invention, symptom probing questions are utilized for other vehicle concerns, which include heating concerns, air conditioning concerns, steering concerns, braking concerns, and smell concerns. It should be understood that symptom probing questions can be utilized for other vehicle concerns, for example, driveability concerns, climate control concerns, vibration concerns, chassis concerns, engine starting concerns, fluid leakage, manual transmission concerns, instrumentation concerns, entertainment system concerns, four wheel drive concerns, suspension concerns, and noise concerns, as long as the information collected from the symptom probing questions helps diagnose vehicle service needs when the vehicle and customer arrives at the dealership. It should also be understood that a GUI is preferably used to present the symptom probing questions to the customer and to collect the customer's responses.

With respect to heating concerns, if the customer enters, for example, “heat”, “heater”, “heating”, “heat duct”, etc., in the data input field of the first service request GUI, the customer is presented with a series of symptom probing questions related to a heating concern.

Preferably, a first symptom probing question relating to the heating concern is, “Please describe the feel of the air being discharged from your heater's vent(s).” Possible responses preferably include, but are not limited to, “No Air Flow”, “Cool”, “Luke Warm”, “Warm”, “Hot”, “Other”, etc. If the customer chooses “Luke Warm” or “Warm”, the customer is prompted with a second symptom probing question: “How Long does it take to warm up your vehicle?” Possible responses to the second symptom probing question preferably include, but are not limited to, a list of time ranges, “Never really warms up”, “Other”, and “Not Sure”. If the customer chooses “Other”, the customer is prompted with a first symptom probing sub-question: “Please indicate specifically how long it takes for the vehicle to warm up.” A third symptom probing question relating to the heating concern is, “At what temperature range do you first start to experience a noticeable lack of heater performance?” Possible responses to the third symptom probing question preferably include, but are not limited to, a list of temperature ranges, “All temperatures” and “Not Sure”.

With respect to air conditioning concerns, if the customer enters, for example, “cool” sub-string, “AC”, “air condition”, etc., in the data input field of the first service request GUI, the customer is presented with a series of symptom probing questions related to an air conditioning concern.

Preferably, a first symptom probing question relating to the air conditioning concern is, “Please describe the feel of the air being discharged from you're A/C vent (s).” Possible responses preferably include, but are not limited to, “Icy Cold”, “Cool”, “Semi-Cool”, “Luke Warm”, “Warm”, “Hot” and “Not Sure”. If the customer chooses “Cool” or “Semi-Cool”, the customer is prompted with a second symptom probing question: “How long does it take to cool your vehicle's interior?” Possible answers to the second symptom probing question preferably include, but are not limited to, a list of times, “Never Really Cools”, “Other”, and “Not Sure”. If the customer chooses “Other”, the customer is prompted with a first symptom probing sub-question: “Please indicate specifically how long it takes.” A third symptom probing question relating to the air conditioning concern is, “At what outside temperature range do you first start to experience a noticeable lack of A/C performance?” Possible responses to the third symptom probing question preferably include, but are not limited to, a list of temperature ranges, “All temperatures”, and “Not Sure”.

With respect to steering concerns, if the customer enters, for example, “steer” sub-string, “wheel”, “turn” sub-string, “drift” sub-string, etc., in the data input field of the first service request GUI, the customer is presented with a series of symptom probing questions related to a steering concern.

Preferably, a first symptom probing question relating to the steering concern is, “When do you notice the steering concern?” Possible responses include, but are not limited to, “All The Time”, “Right Turns”, “Left Turns”, “Breaking Hard”, “Rainy Days”, “Other”, and “Not Sure”. If the customer chooses “Other” in response to the first symptom probing question, the customer is prompted with a first symptom probing sub-question: “Please indicate specifically when you experience the steering concern.” A second symptom probing question is, “At what speed or speed range is your steering concern most noticeable?” Possible responses include, but are not limited to, a list of speed ranges, “All Speeds” and “Not Sure”. A third symptom probing question is, “Please indicate if you noticed any of the following symptoms.” Preferably, a GUI displays a list of possible symptoms and the customer is prompted to click on the symptoms applicable to the customer's problem. Possible symptoms include, but are not limited to, “Steering Binds Up”, “Hard Steering”, “Tight Steering”, “Creaking Noise”, “Steers Left”, “Pulls Right”, “Not Sure”, etc.

With respect to braking concerns, if the customer enters, for example, “brake” sub-string, “stop” sub-string, “shoe”, “pad”, “rotor”, “drum”, etc., in the data input field of the first service request GUI, the customer is presented with a series of symptom probing questions related to a braking concern.

Preferably, a first symptom probing question relating to the braking concern is, “When do you notice the braking concern?” Possible responses include, but are not limited to, “All The Time”, “Braking Soft”, “Driving Uphill”, “Rainy Weather”, “Very Hot Weather”, “Other”, and “Not Sure”. If the customer chooses “Other” in response to the first symptom probing question, the customer is prompted with a first symptom probing sub-question: “Please indicate specifically when you experience the braking concern.” A second symptom probing question is, “At what speed or speed range is your braking concern noticeable?” Possible responses include, but are not limited to, a list of speed ranges, “All Speeds”, and “Not Sure”. A third symptom probing question is, “Please indicate if you also noticed any of the following symptoms.” Preferably, a GUI displays a list of possible symptoms and the customer is prompted to click on the symptoms applicable to the customer's problem. Possible symptoms include, but are not limited to, “Pedal Pulsation”, “Hard Pedal”, “Spongy Pedal”, “Low Pedal”, “Grinding Noise”, “ABS Light”, etc.

With respect to smell concerns, if the customer enters, for example, “smoke” sub-string, “sulfur”, “musty” sub-string, “exhaust”, “fume”, “rotten egg”, etc., in the data input field of the first service request GUI, the customer is presented with a series of symptom probing questions related to a smell concern.

Preferably, a first symptom probing question relating to the smell concern is, “Please describe what the odor smells like.” Possible responses include, but are not limited to, “Rotten Eggs”, “Sulfur Odor”, “Gasoline Fumes”, “Anti-Freeze”, “Other”, and “Not Sure”. If the customer chooses “Other” in response to the first symptom probing question, the customer is prompted with a first symptom probing sub-question: “Please indicate specifically what the odor smells like.” A second symptom probing question is, “Where does the odor appear to be coming from?” Possible responses include, but are not limited to, “Engine Area”, “Vehicle Interior”, “Trunk/Cargo Area”, “Heating Vents”, “Vehicle Front”, “Right Side”, “Left Side”, “Other”, and “Not Sure”. If the customer chooses “Other” in response to the second symptom probing question, the customer is prompted with a second symptom probing sub-question: “Please indicate specifically where you smell it.” A third symptom probing question is, “When do you smell the odor?” Possible responses to the third symptom probing question preferably include, but is not limited to, “All the Time”, “Braking”, “After it Rains”, “Steady Speed”, “Other” and “Not Sure”. If the customer chooses “Other” in response to the third symptom probing question, the customer is prompted with a third symptom probing sub-question: “Please indicate specifically when you smell it.”Once the customer completes answering the symptom probing question for the service request, the customer can enter information regarding another service request.

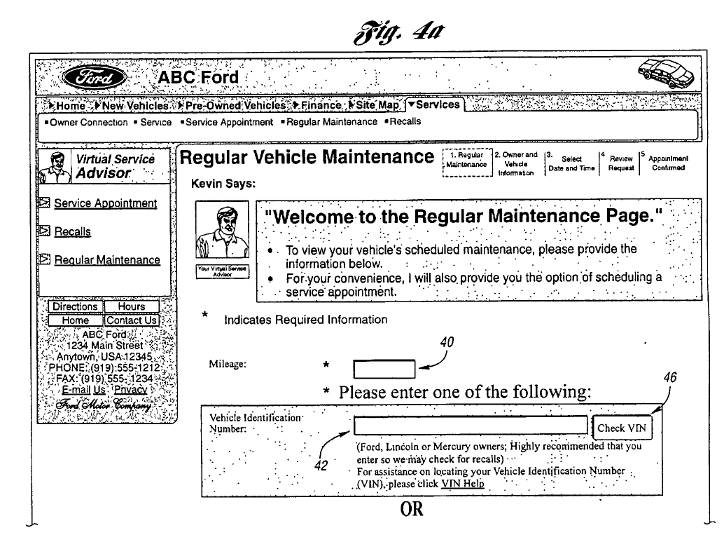

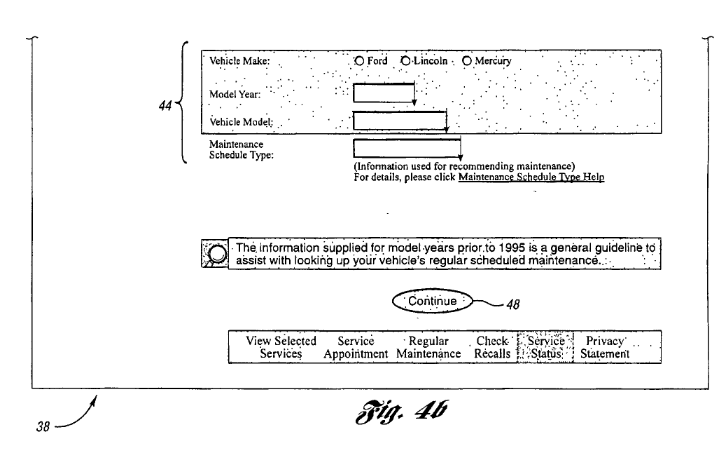

If the customer identifies the vehicle maintenance inquiry, an at least one GUI hosted by server 12 is preferably utilized for entering the information pertinent to the vehicle maintenance inquiry. FIGS. 4a and 4b illustrate a preferred GUI 38 hosted by server 12 for entering the information pertinent to the vehicle maintenance inquiry. Preferably, the customer is prompted to enter the mileage of the vehicle in data input field 40. The customer is also prompted to either enter the vehicle identification number (“VIN”) in data input field 42 or enter the vehicle make, the model year, the vehicle model, and the maintenance schedule type in data input fields 44. If the customer selects the “Check VIN” button 46, the VIN entered into VIN input field is verified as valid on server 12 by operating module 24 for VIN decoding. If the VIN entered by the customer is not valid, the customer is prompted to check the VIN number and re-enter it. Upon selecting “Continue” button 48, the vehicle specific maintenance module 24 uses the data entered into data fields 40 and 42 or 44 to retrieve the vehicle maintenance information, which includes, but is not limited to, OEM recommended current service interval, OEM recommended next service interval, and OEM previous major service interval.

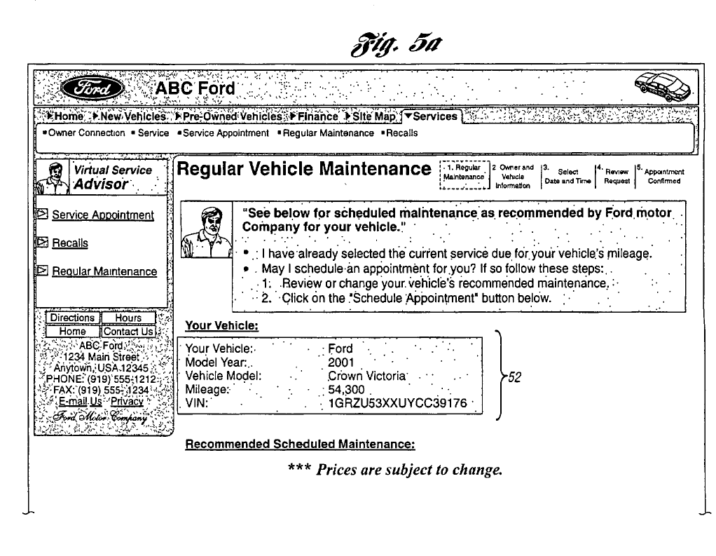

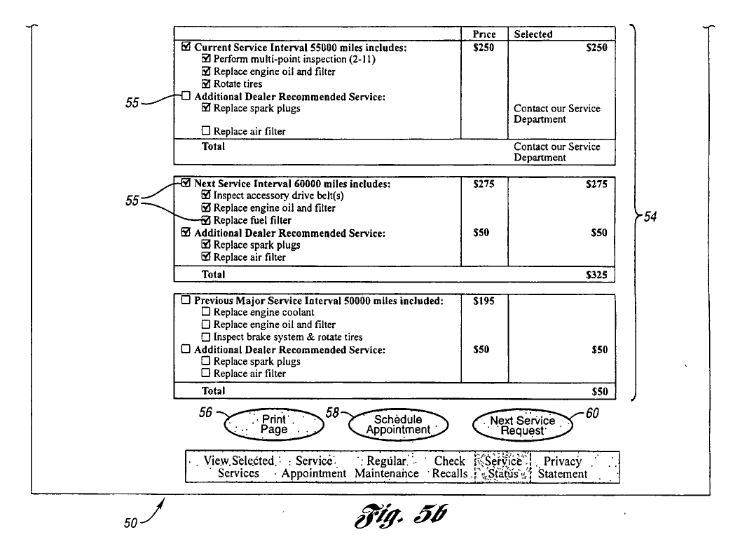

The vehicle maintenance information is sent from server 12 through network 20A to customer computer 14 and is preferably displayed as GUI 50 as illustrated in FIGS. 5a and 5b. Preferably, GUI 50 contains customer vehicle information 52 and recommended scheduled maintenance information 54. The recommended scheduled maintenance information 54 preferably includes information regarding OEM recommended current service interval, OEM recommended next service interval, and OEM previous major service interval. In addition, information can be displayed regarding dealer recommended service and dealership maintenance pricing, if available. Preferably, server 12 obtains dealer recommended service information or dealership maintenance pricing through network 20B, using information provided by dealer in-house computers 16A-16N or dealer middleware server 22. GUI 50 also preferably includes check boxes 55 for the customer to select the desired maintenance.

GUI 50 also contains “Print Page” button 56, “Schedule Appointment” button 58, and “Next Service Request” button 60. Upon selecting “Print Page” button 56, the consumer is prompted to select a printer for printing the information that is displayed as part of GUI 50. Upon selecting “Next Service Request” button, the GUI for identifying a service inquiry is displayed. Upon selecting “Schedule Appointment” button 58, the customer is prompted to select an appointment date and time.

If the customer selects the recall inquiry, an at least one GUI hosted by server 12 is preferably utilized for entering information pertinent to the recall inquiry. Preferably, a GUI contains a data input field for entering the VIN. After the customer enters the VIN, the customer selects the “Continue” button. The VIN entered into data input field is verified as valid on server 12 by operating module 24 for VIN decoding the VIN entered by the customer is not valid, the customer is prompted to check the VIN number and re-enter it. Once the VIN is verified, the check recall module 24 determines whether any recalls exist for the customer vehicle.

If no recalls exist, a message is preferably displayed as part of a GUI that states, “Based on the Vehicle Identification Number entered, there are no open recalls for your vehicle.” If recall(s) exist, a message is preferably displayed as part of a GUI that states, “Based on the Vehicle Number entered, see below for identified recall(s) for your vehicle.” The GUI also preferably includes vehicle information (VIN, the vehicle make, the vehicle model, the model year, etc.) and the identified recalls. The GUI also preferably contains a “Schedule Appointment” button and a “Next Service Request” button. Upon selecting “Next Service Request” button, the GUI for identifying a service inquiry is displayed.

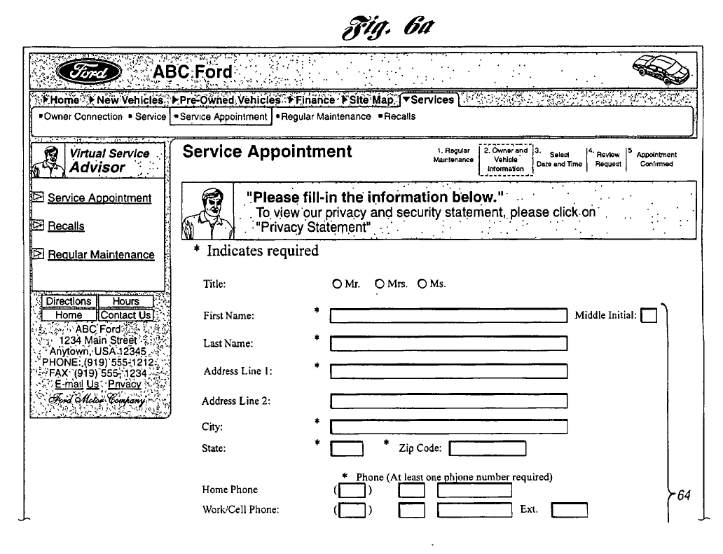

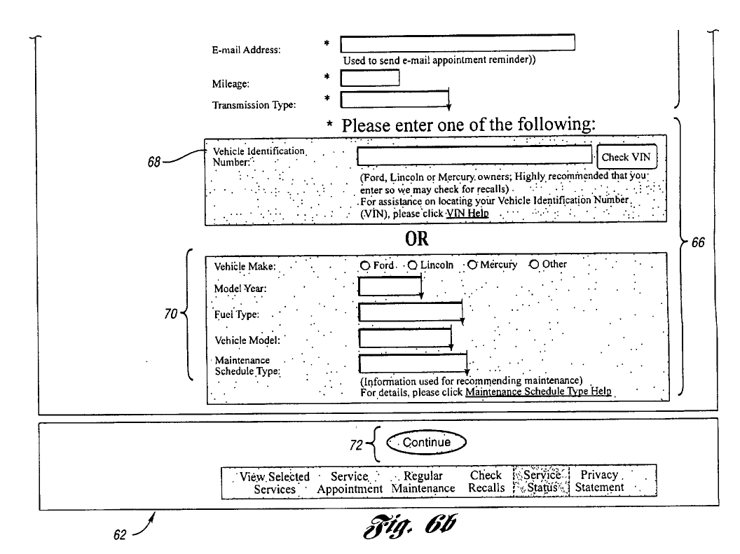

Upon selecting “Schedule Appointment” button, the customer is prompted to enter owner and vehicle information, as represented in block 30 of FIG. 2. FIGS. 6a and 6b illustrate a preferred GUI 62 hosted by server 12 for entering owner and vehicle information. GUI 62 comprises a plurality of data input fields 64 and 66 for defining owner and vehicle information, respectively. Data input fields 64 include, but are not limited to, customer title, first name, middle initial, last name, address, city, state, zip code, home phone, work phone, cell phone, e-mail address, mileage, and transmission type. The customer is also prompted to either enter the vehicle identification number (“VIN”) in data input field 68 or enter the vehicle make, the model year, the vehicle model, and the maintenance schedule type in data input fields 70. Upon selecting “Continue” button 72, the owner and vehicle information is checked to verify that the customer has entered data in the required input fields. The required input fields are preferably first name, last name, address, city, state, zip code, e-mail address, mileage, and transmission type. If the customer neglects to enter data in at least one of the required input fields, a window preferably appears on computer 14 alerting the customer of the missing data. In addition, if the customer enters the VIN, the VIN is verified as valid on server 12 by operating module 24 for VIN decoding. If the VIN entered by the customer is not valid, the customer is prompted to check the VIN number and re-enter it. The verified owner and vehicle information at least temporarily resides on server 12.

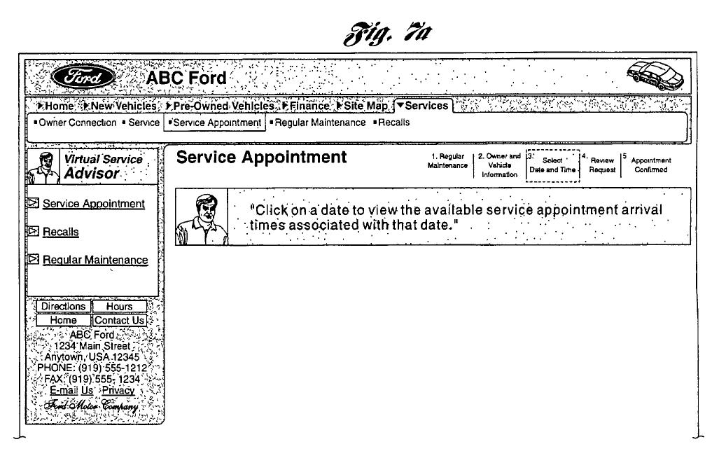

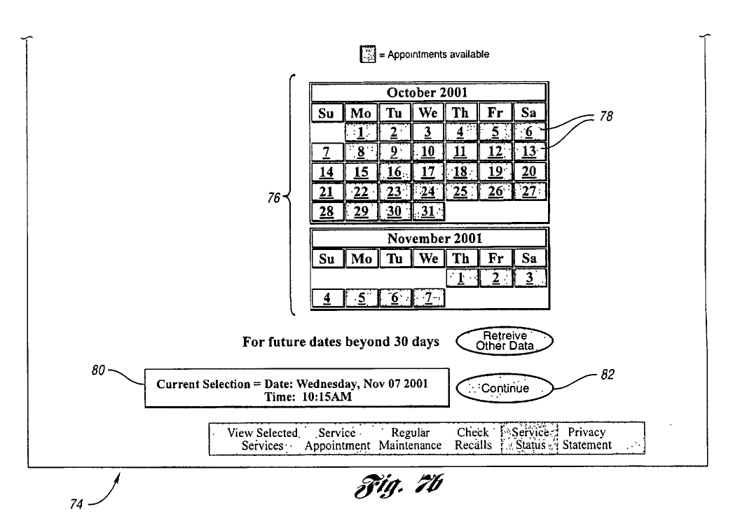

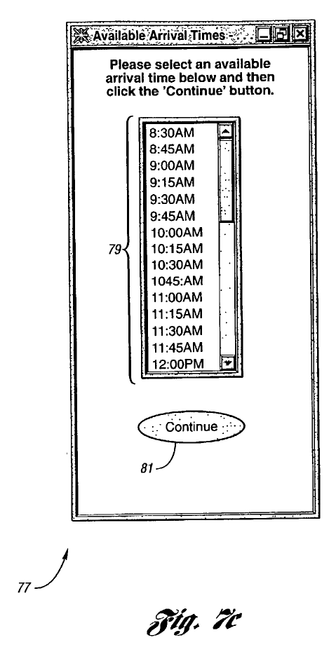

As represented in block 32, the customer selects an appointment date and arrival time. FIGS. 7a and 7b illustrate a preferred GUI 74 for scheduling an appointment date and time. GUI 74 contains a calendar 76 wherein the customer can preferably select available dates 78 on calendar 76. The information on the calendar 76 is provided by a dealer in-house computer or the dealer middleware server. Preferably, a request XML package is sent to dealer server 16 or dealer middleware server 22 to request available appointment dates and arrival times. The communication between server 12 and dealer server 16 or dealer middleware server 22 is asynchronous and generally comprises server 12 sending the request XML package and receiving a response XML from either dealer server 16 or dealer middleware server 22 via SOAP protocol. Table 1 contains an example of the request XML package for requesting service appointment times in a 30 day window. It should be understood that the content, arrangement and language of the generic request XML package of Table 1 can be rearranged, modified and/or supplemented to best fit the communication between server 12 and dealer server 16 and dealer middleware server 22.

TABLE 1
[t1]

<?xml version=“1.0” standalone=“no” ?>
<!DOCTYPE ApptRequest SYSTEM “ApptRequset.dtd”>
<ApptRequest>

<Transaction Sessionid=“ {6EBAA42A-244A-458F-AF78-221C3CA16806}”
StartDate=“10/18/2001” Dealerid=“6055” StoreBranch=“”/>

</ApptRequest>

Preferably, the dealer server 16 or dealer middleware server 22 returns the response XML package, with 30 days of date and time openings for an appointment. Table 2 contains an example of the response XML package from dealer server 16 or dealer middleware server 22, sending available appointment times for the 30 day window.

TABLE 2
[t2]

<?xml version=“1.0” encoding=“UTF-8”?>
<!-- DOCTYPE OpenAppts SYSTEM “OpenAppointment.dtd”-->
<openAppts sessionID=“ {6EBAA42A-244A-458F-AF78-221C3CA16806}”
dealerID−“6055”>

<ResponseStatus Status=“Success” StatusCode=“200”

Date=“10/12/2001” Time=“01:18 PM”>

<openSlots Date=“10/12/2001”>

<time>

01:15 PM

</time>
<time>

01:30 PM

</time>

</openSlots>
<openSlots Date=“10/13/2001”>

<time>

09:30 AM

</time>
<time>

10:30 AM

</time>

</opeSlots>

</openAppts

Upon selecting an available date 76, the customer is preferably presented with a pop-up window 77 that lists available arrival times 79, as illustrated in FIG. 7c. The customer preferably selects an available arrival time 79 and then selects a “Continue” button 81. Upon selecting the “Continue” button 81, the current date and arrival time selection 80 is displayed as part of GUI 74 of FIGS. 7a and 7b. Once the customer is satisfied with the current date and time selection 86, the customer selects “Continue” button 82.

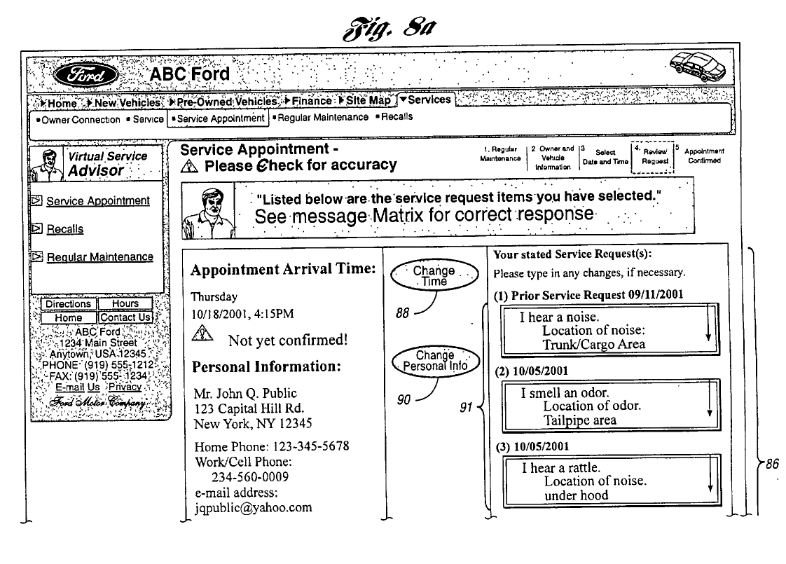

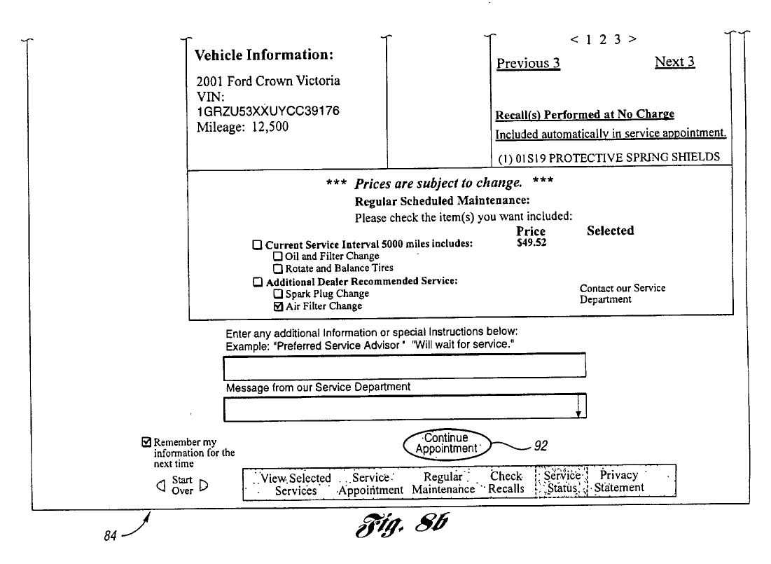

After selecting “Continue” button 82, the customer reviews the information relevant to the customer request(s) for accuracy, as depicted in block 34. FIGS. 8a and 8b illustrate a preferred GUI 84 for displaying the information relevant to the customer request(s) for the customer's review. The displayed information 86, includes, but is not limited to, appointment date and arrival time, personal information, vehicle information, service request(s) information, recalls (if any), and selected regular maintenance schedule. GUI 84 also contains “Change Time” button 88 and “Change Personal Info” button 90. The contents of text boxes 91 can be edited by the customer to reflects their service inquiry. Upon selecting either button, the customer is preferably prompted with a pop-up window for editing either the appointment date and arrival time or the personal information.

As depicted in block 36, the appointment date and time is confirmed after selecting the “Continue Appointment” button 92. The information collected regarding the customer request, including, but not limited to appointment date and arrival time, personal information, vehicle information, service request(s) information, and regular maintenance schedule is sent to dealer server 16 or dealer middleware server 22 via a request XML package across network 20b. Table 3 contains an example of the request XML package for making the service appointment.

TABLE 3
[t3]

<?xml version=“1.0” standalone=“no” ?>
<!DOCTYPE Appointment SYSTEM “Appointment.dtd”>
<Appointment>

<Transaction Sessionid=“ {6EBAA42A-244A-458F-AF78-221C3CA16806}”

Dealerid“6055” StoreBranch=“ ”22

<VehicleData Vin=“1FMYU04131KB51071” VehModelYr=“2001”

VehMake=“FORD” VehModel=“ESCAPE” VehMileage=“12000”/>

<ServiceRequests id=“1A”>

noise

Location of noise: Vehicle Front.
Occasion of noise: Right Turns.
Strength of noise: Mid Sometimes

</ServiceRequests>
</MaintRequests>
<MaintReguests>

<Bundle ReportType=“Current” BundleSource=“Dealer”
BundlePrice=“$12.45”>

Change Air Filter

</Bundle>

</MaintRequests>

<Recall Recallid=“00E10” RecallDesc=“ ”/>

<Comments>

Need to get the car greased

</Comments>

<CustomerData CustFirstName=“Jambulingam” CustLastName=“Devarajan”
CustInit=“N” CustSalutation=“Mr” Custphone=“3451314545”
CustEmail=“jay@ford.com” CustAddress1=“123 Main St” CustAddress2=“Apt”
00” CustCity=“Westland” CustState=“MI” CustZip=“48186”
Wkphone=“1231233422” WkPhoneExt=“ ”/><RequestedAppt Date=“10/12/2001”
Time=“01:30 PM”/>

</Transaction>

</Appointment>

The dealer server 16 or dealer middleware server 22 returns a response XML package, confirming or rejecting the service appointment request. Table 4 contains an example of a response XML package from dealer server 16 or dealer middleware server 22 acknowledging confirmation or rejection of the server appointment request.

TABLE 4
[t4]

<?xml version=“1.0” encoding=“UTF-8”?>
<!-- DOCTYPE Confirmation SYSTEM “Sendconfirmation.dtd” -->
<Confirmation>

<ResponseStatus Status=“Success” StatusCode=“200”

Date=“10/12/2001” Time=“02:02 PM”/>

<Transaction Sessionid=“ {6EBAA42A-244A-458F-AF78-
221C3CA16806} Dealerid=“6055”

Confirmed=“Yes”>

<Appointment Date=“10/13/2001” Time=“02:00 PM”/>

</Transaction>

</Confirmation>

If the appointment time and arrival date is not available, a GUI preferably displays a message that states the appointment date and arrival time is not available. The GUI preferably contains a “Retrieve Other Dates” button. Upon selecting the “Retrieve Other Dates” button, the preferred GUI 92 for scheduling an appointment date and time is displayed. If server 12 is having problems communicating with dealer server 16 or dealer middleware server 22, then the customer is prompted to retry by preferably clicking on a “Retry” button.

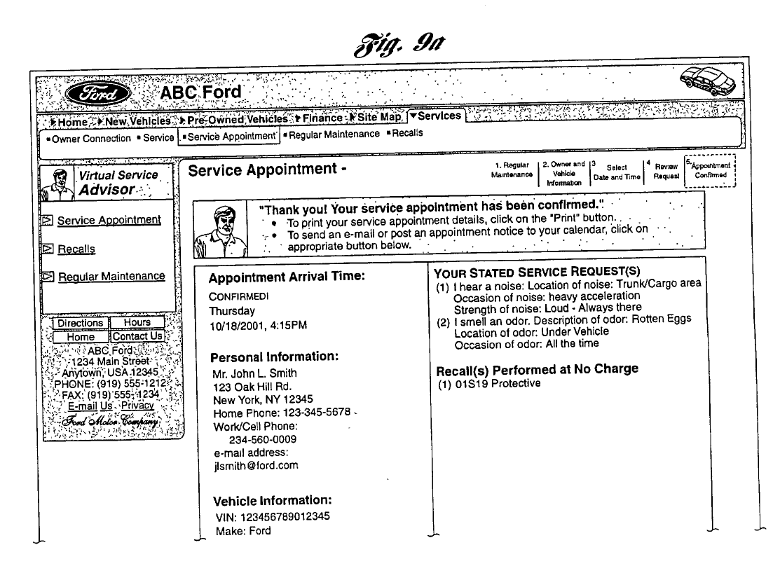

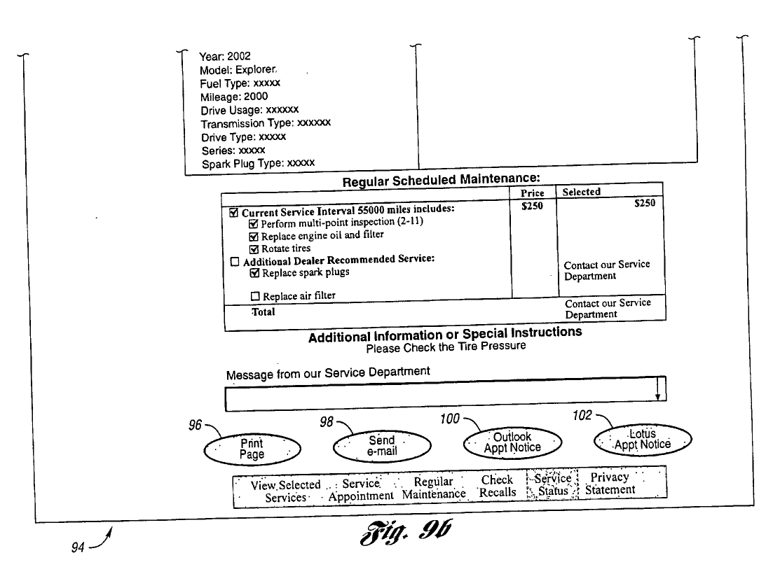

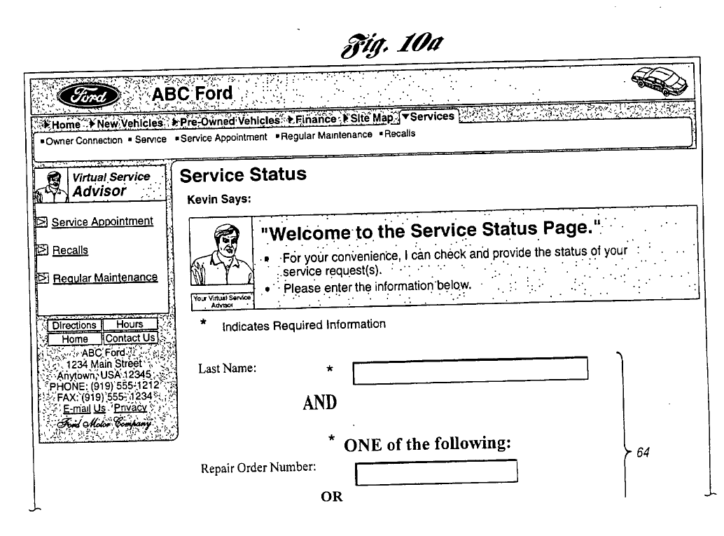

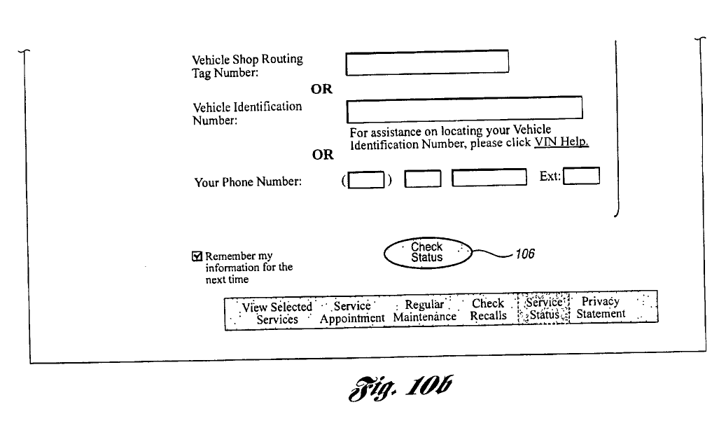

Once the acknowledgment is received by the dealer server 16 or dealer middleware server 22, a preferred GUI 94 displays information confirming the appointment, as illustrated in FIGS. 9a and 9b. In the case of server 18, dealer middleware server 22 pushes the information collected regarding the customer request to server 18. GUI 94 can include, but is not limited to, appointment date and time, personal information, vehicle information, service request(s) information, recall (s) information, and regular scheduled maintenance information. GUI 94 also preferably includes a “Print Page” button 96, a “Send e-Mail” button 98, an “Outlook Appointment Notice” button 100, and a “Lotus Appointment Notice” button 102. Upon selecting “Print Page” button 96, the consumer is prompted to select a printer for printing the information that is displayed as part of GUI 94. Upon selecting “Send e-Mail” button 96, the customer is prompted to select an e-mail address for sending the information that is displayed as part of GUI 94. Upon selecting either the “Outlook Appointment Notice” button 100 or “Lotus Appointment Notice” button 102, the information displayed on GUI 94 is imported into either Outlook or Lotus, respectively.

As depicted in block 31 of FIG. 2, another aspect of the present invention relates to a method and system of checking the status of a service request. It should be understood that the service request need not be initiated by using the customer user interface module 24. For example, after a customer arrives at a dealership and requests service, a dealership representative can recommend that the customer checks the vehicle service status by using the customer user interface of the present invention.

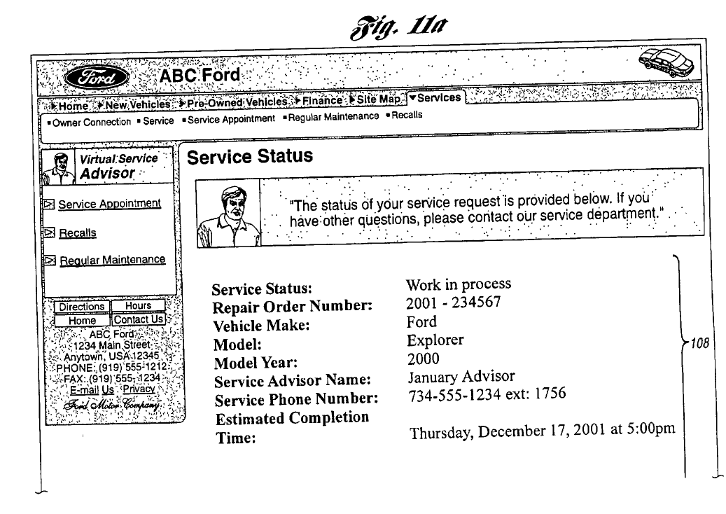

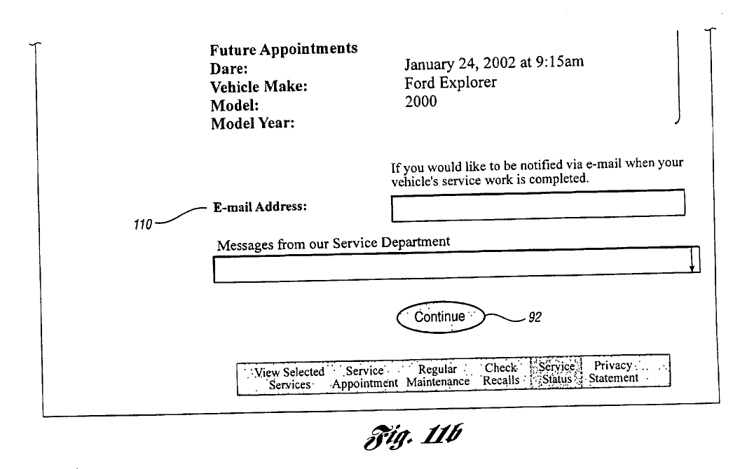

As represented in block 28 of FIG. 2, the customer enters vehicle information regarding the vehicle service status inquiry. Preferably, a GUI, as illustrated in FIGS. 11a and 11b contains data input fields 104 for entering information necessary to check the vehicle service status. Preferably, checking the vehicle service status requires a customer to enter his/her last name and one of the following: repair order number, vehicle shop routing tag number, vehicle identification number, or phone number. GUI also preferably contains an “Check Status” button 106. Upon selecting the “Check Status” button 106, the information entered into the data input fields is sent to server 12 and the information is used by the check vehicle status module 24. The check vehicle status module 24 sends a request XML package to dealer server 16 or dealer middleware server 22 to request the status of a vehicle repair. A response XML package is sent back through dealer server 16 or dealer middleware server 22, which contains information regarding the status of the vehicle service request.

As represented in block 31, the customer is presented with vehicle service status information. Preferably, a GUI, as illustrated in FIGS. 11a and 11b, is used to display service status information 108 as displayed as part of a GUI. Pieces of service status information to be displayed on the preferred GUI include, but are not limited to service status (e.g., work in progress or work completed), repair order number, vehicle make, model, model year, service advisor name, service phone number, estimated completion time, future appointments date, vehicle make, model, and model year. Additionally, the customer can enter his/her e-mail address in an data input field 110 if the customer would like to be notified via e-mail when the vehicle service is completed.

While the best mode for carrying out the invention has been described in detail, those familiar with the art to which this invention relates will recognize various alternative designs and embodiments for practicing the invention as defined by the following claims.

1. An online method for advising a customer on service needs and facilitating the scheduling of a vehicle service appointment, the method comprising:
receiving a service inquiry wherein the service inquiry is selected from the group comprising: a service request, a scheduled maintenance request, and a recall request;
receiving input information regarding the potential service of the vehicle wherein if the service inquiry is a service request, the input information includes information defining vehicle symptoms pertinent to the service request or if the service inquiry is the scheduled maintenance request or the recall request, the input information includes a vehicle identification number or the vehicle make, vehicle model year, and vehicle model wherein the input information is used to determine whether service is advised for the vehicle; and
transmitting the input information and an appointment request to a vehicle service provider to facilitate the scheduling of the vehicle service appointment.

2. The online method of claim 1 wherein the service inquiry is the service request and wherein the input information defining vehicle symptoms pertinent to the service request includes a vehicle symptom string.

3. The online method of claim 2 further comprising determining an at least two symptom probing questions based on the vehicle symptom string.

4. The online method of claim 3 further comprising transmitting to the customer the at least two symptom probing questions.

5. The online method of claim 4 further comprising transmitting to the vehicle service provider the answers to the at least two symptom probing questions.

6. The online method of claim 1 wherein the service inquiry is selected by the customer.

7. The online method of claim 1 further comprising receiving available appointment dates and arrival times from the vehicle service provider.

8. The online method of claim 1 wherein the service inquiry is the vehicle maintenance request and further comprising retrieving a vehicle maintenance schedule for the vehicle based on the input information.

9. The online method of claim 1 wherein the service inquiry is the recall request and further comprising determining whether a recall exists for the customer's vehicle based on the input information.

10. The online method of claim 1 further comprising transmitting to the customer the input information to the customer prior to transmitting the input information and the appointment request.

11. An online vehicle service method comprising:
receiving a service inquiry wherein the service inquiry is selected from the group comprising: a service request, a scheduled maintenance request, a recall request, and a vehicle status request;
receiving input information regarding the potential service of the vehicle wherein if the service inquiry is a service request, the input information includes information defining vehicle symptoms pertinent to the service request or if the service inquiry is the scheduled maintenance request or the recall request, the input information includes a vehicle identification number or the vehicle make, vehicle model year, and vehicle model wherein the input information is used to determine whether service is advised for the vehicle or if the service inquiry is the vehicle status request, the input information includes an at least last name of a customer checking on the vehicle status wherein the input information is used to determine the vehicle status; and
transmitting the input information and an appointment request to a vehicle service provider to facilitate the scheduling of the vehicle service appointment.

12. The online method of claim 11 wherein the service inquiry is the vehicle status request and further comprising receiving vehicle status information from the vehicle service provider.

13. The online method of claim 12 further comprising transmitting to the customer vehicle status information.

14. An online system for advising a customer on service needs and facilitating the scheduling of a vehicle service appointment, the system comprising at least one server computer operably serving at least one client computer, the at least one server computer configured to:
(i) receive a service inquiry wherein the service inquiry is selected from the group comprising: a service request, a scheduled maintenance request, and a recall request;
(ii) receive input information regarding the potential service of the vehicle wherein if the service inquiry is a service request, the input information includes information defining vehicle symptoms pertinent to the service request or if the service inquiry is the scheduled maintenance request or the recall request, the input information includes a vehicle identification number or the vehicle make, vehicle model year, and vehicle model wherein the input information is used to determine whether service is advised for the vehicle; and
(iii) transmit the input information and an appointment request to a vehicle service provider to facilitate the scheduling of the vehicle service appointment.

15. The online system of claim 14 wherein the at least one server computer is additionally configured to receive available appointment dates and arrival times from the vehicle service provider.

16. The online system of claim 15 wherein the at least one server computer is additionally configured to transmit a request XML package containing a request for available appointment dates and arrival times to the vehicle service provider and to receive a response XML package containing available appointment dates and arrival times.

17. The online system of claim 16 wherein the at least one server computer is additionally configured to transmit a request XML package containing the appointment date and arrival time for the vehicle service appointment to a dealer server or dealer middleware server and to receive a response XML confirming the appointment date and arrival time.

18. The online method of claim 14 wherein the service inquiry is the service request and wherein the input information defining vehicle symptoms pertinent to the service request includes a vehicle symptom string.

19. The online method of claim 18 further comprising determining an at least two symptom probing questions based on the vehicle symptom string.

20. The online method of claim 19 further comprising transmitting to the customer an at least two symptom probing questions.
